(19) United States
(12) Patent Application Publication
(10) Pub. No.: US 2004/0028374 A1
(43) Pub. Date: Feb. 12, 2004

(54) Multi-AV control device in an automobile

(76) Inventors: Wen-yen Shen, Pate City (TW); Shun-Ching Chen, Pate City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/212,776

(22) Filed: Aug. 7, 2002

(51) Int. Cl. H04N 5/76

(52) U.S. Cl. 386/46; 386/125

(57) ABSTRACT

The present invention relates to a multi-AV control device in an automobile which consists of a multi-AV device and a plurality of displays. The multi-AV device is connected with a plurality of AV-signal input sources and the displays. The multi-AV device is controllable by press buttons or a remote control of every display to choose different AV-signal source while the chosen AV-signal source is shown on corresponding display. The control command is given by the displays to the multi-AV device, whereupon the multi-AV device transmits signals back to the display and which are shown on the corresponding display so that this two-way communication achieves control and display effect. Accordingly, the present invention can achieve a more convenient and accurate operation in choosing desired AV-signals.

### BACKGROUND OF THE INVENTION

1. Field of the Invention

The present invention relates to a multi-AV (audiovisual) control device in an automobile, and more particularly, to a device comprising one multi-AV device and several displays. Control commands can be given by any of the displays to the multi-AV device while the signals chosen by users is transmitted by the multi-AV device back to the corresponding display. Accordingly, this two-way communication can achieve the control and display effects.

2. Description of the Prior Art

With the rapid development of audio/video technique, car stereo has developed from cassettes to CDs. At present, you can even sit in an automobile to enjoy TV, VCD or DVD programs.

The current audio/video device in an automobile includes one VCD or DVD player in combination with a display. Therefore, the display can only receive the audio/video signals sent by VCD or DVD player arranged within the automobile or the trunk. The user has no other choices. Since the system of “two days off weekly” and outdoor travel becomes more and more popular, it's more often that the whole family or a few friends take a recreation vehicle outdoors. However, only one player is available in the automobile and it doesn't meet the different needs of users. If more displays are installed with only one player, only one displayed frame can be received. This just can't meet the requirement of every passenger. Besides, the conventional installation way is one player with one display which serves to passively receive the AV-signals from the connected player. In other words, the passenger can't choose desired displayed frame or game programs from the display. For example, front-seat passenger wants to enjoy DVD programs, but the display is connected to TV channel selector. And rear-seat passengers want to enjoy TV programs, but the display is connected to DVD player. This results in much trouble and inconvenience.

In addition, an audio/video switching device is available in the karaoke system. The desired audiovisual output signal is chosen by means of electronic switch circuit. However, this system has not only many electronic devices but also complicated wiring. Moreover, two-way communication can't be achieved. As a result, it's not suitable that this system is installed within cars.

### SUMMARY OF THE INVENTION

It is a primary object of the present invention to provide a multi-AV control device in an automobile which consists of a multi-AV device and a plurality of displays. The multi-AV device is connected with a plurality of AV-signal input sources and the displays. The multi-AV device is controllable by press buttons or a remote control of every display to choose different AV-signal source while the chosen AV-signal source is shown on corresponding display. The control command is given by the displays to the multi-AV device, whereupon the multi-AV device transmits signals back to the display and which are shown on the corresponding display so that this two-way communication achieves control and display effect. Accordingly, the desired AV-signals can be received by displays through wire or wireless transmission.

### BRIEF DESCRIPTION OF THE DRAWINGS

The accomplishment of this and other objects of the invention will become apparent from the following description and its accompanying drawings of which:

FIG. 1 is a perspective view of the installation of an applicable embodiment in accordance with the present invention;

FIG. 2 is a block diagram of main elements of the present invention;

FIG. 3A is a front view of the multi-AV device of the present invention;

FIG. 3B is a rear view of the multi-AV device of the present invention;

FIG. 4 is a front view of the display of the present invention;

FIG. 5 is a block diagram of the multi-AV device of the present invention;

FIG. 6 is a block diagram of the displays of the present invention;

FIG. 7 is a transmission flow chart of the present invention; and

FIG. 8 is a reception flow chart of the present invention;

### DETAILED DESCRIPTION OF THE PREFERRED EMBODIMENT

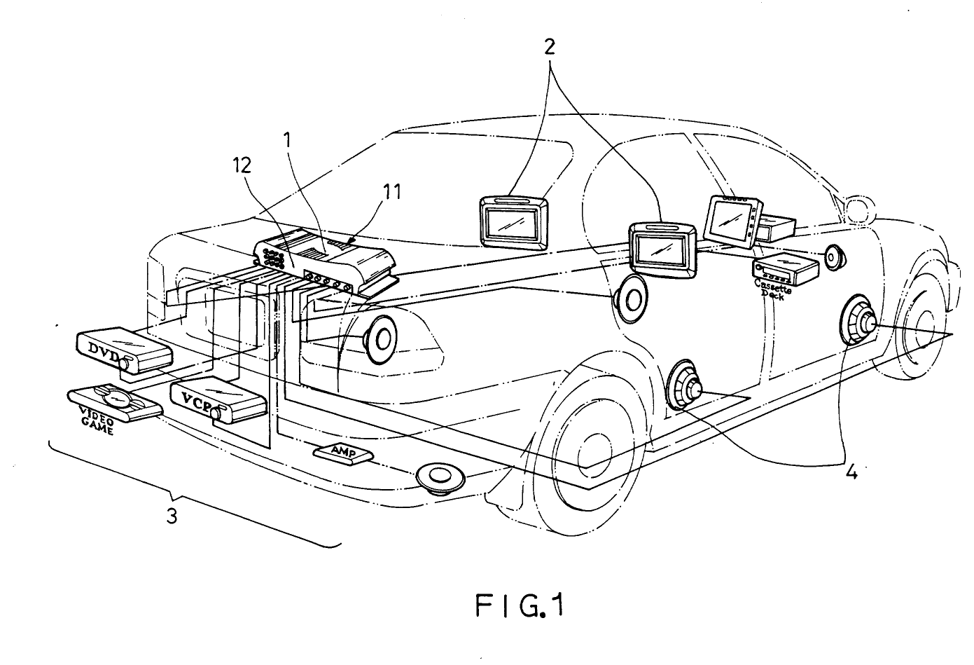

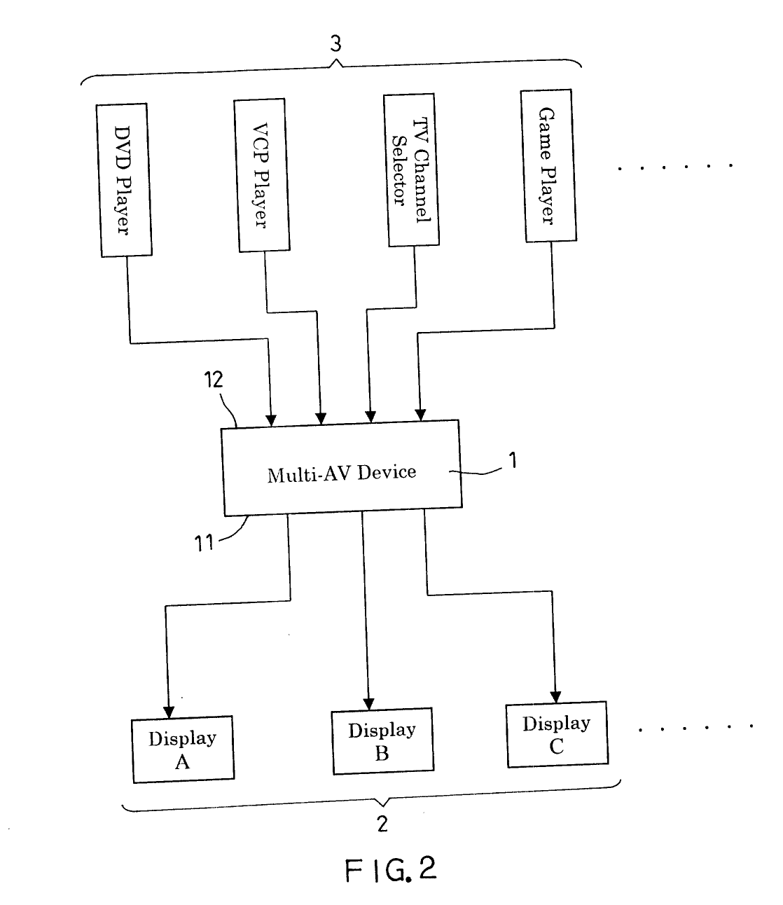

First of all, referring to FIGS. 1 and 2, the present invention includes a multi-AV device 1 and several displays 2. The multi-AV device 1 is arranged in the trunk or at other available room. The displays 2 are installed in front of seats within an automobile or at other suitable places thereof.

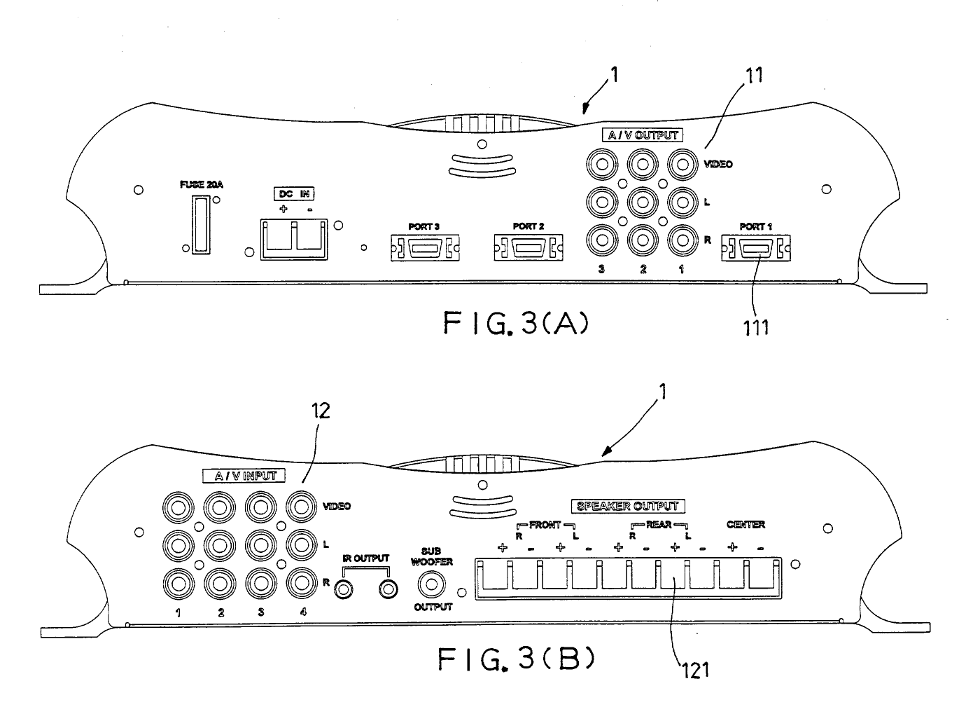

The multi-AV device 1 is in connection with a plurality of AV-signal input sources 3 and displays 2. FIG. 3A shows an applicable embodiment of output interface 11 of the present invention. The output interface 11 includes a plurality of terminals which are connected with displays 2 through signal cables. Connection ports 111 (PORT1-PORT 3) are in connection with displays 2, respectively, so that signals of the multi-AV device 1 can be controlled or adjusted through the displays 2. FIG. 3A shows an applicable embodiment of input interface 12 of the present invention. The input interface 12 serves to connect with AV-signal input sources 3. The right side thereof is output port 121 for car speakers 4. The multi-AV device 1 of the present invention is not commercially available, and the internal arrangement thereof will be described hereinafter.

The aforementioned AV-signal input sources 3 comprises a DVD player, VCP player, TV channel selector, game player, etc.

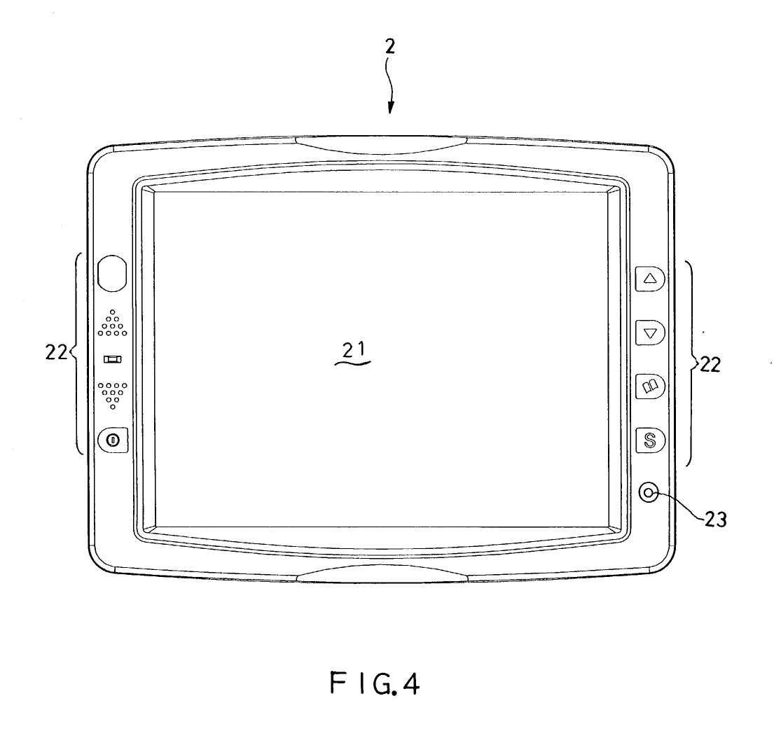

As shown in FIG. 4, it's preferable that the display 2 is constructed as LCD so as to occupy less space. The display 2 is also extra designed for the present invention so that it's not commercially available. The LCD panel 21 includes a plurality of control buttons 22 and a headphone jack 23 at the side thereof.

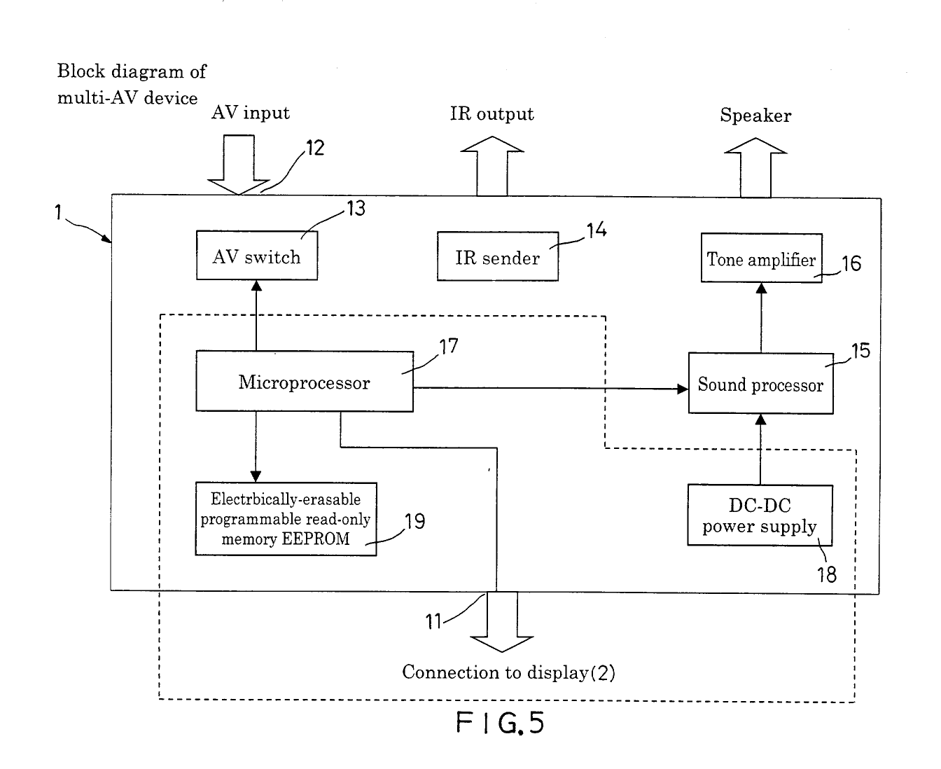

Referring to FIG. 5, the multi-AV device 1 includes an AV switch 13, an IR-sender 14, a sound processor 15 and a tone amplifier 16, and is connected with the car speaker 4. In addition, the multi-AV device 1 has a microprocessor 17. A DC-DC power supply 18 is utilized to supply DC voltage. The microprocessor 17 is connected with the AV switch 13, the sound processor 15 and an electrically-erasable programmable read-only memory EEPROM 19. Through the output interface 11, the microprocessor 17 is connected with the display 2.

The microprocessor 17 is different from the conventional microprocessor and extra designed for the displays 2.

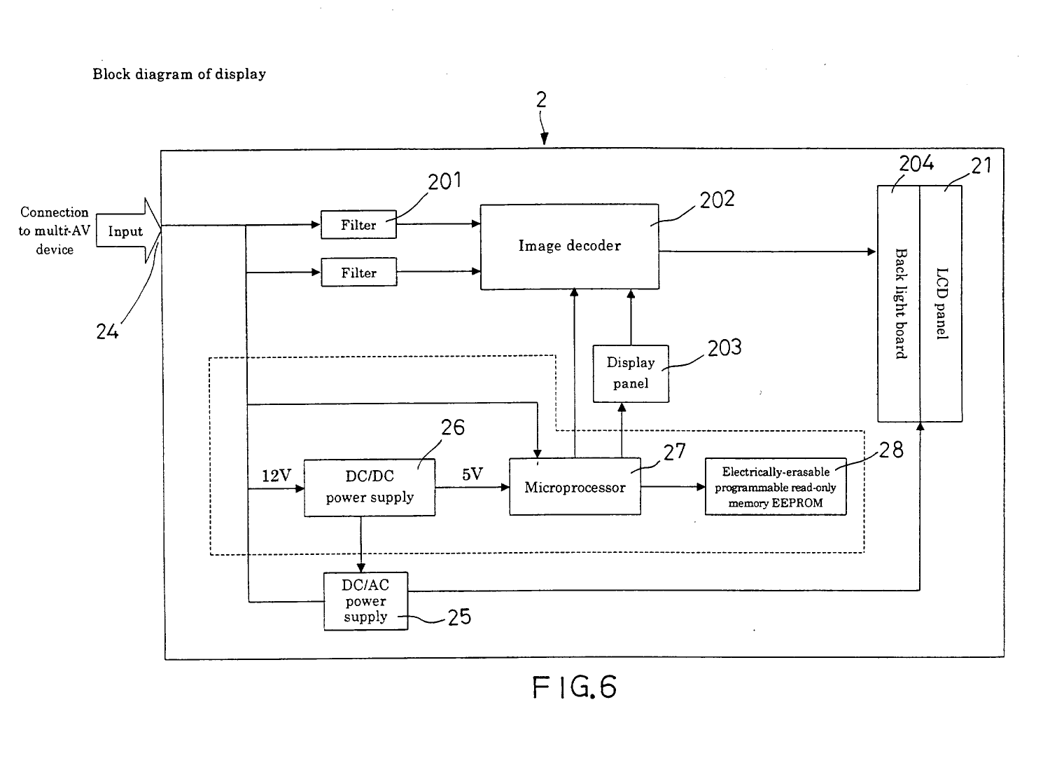

FIG. 6 shows a block diagram of the display 2 which includes a filter 201 normally required by conventional LCD, an image decoder 202, a display panel 203, a back light board 204, an LCD panel 21 and a DC-AC power supply 25. The display 2 is connected to the microprocessor 27 through an output interface 24. Besides, a DC-DC power supply 26 is used to supply DC voltage. Moreover, the microprocessor 27 is connected with the image decoder 202, the display panel 203 and the electrically-erasable programmable read-only memory EEPROM 28.

Based upon the above-mentioned, the multi-AV device 1 can be controlled to choose different AV signal sources by means of the control buttons 22 on the displays 2. Meanwhile, the chosen AV-signal will be shown on the corresponding display 2.

The control command is given by the displays 2 to the multi-AV device 1. Thereafter, the multi-AV device 1 transmits signals back to the display 2 and which are shown on the corresponding display 2. Therefore, this two-way communication achieves control and display effect. The communication between the displays 2 and the multi-AV device 1 can be carried out through wire or wireless transmission. This won't be described any more hereinafter.

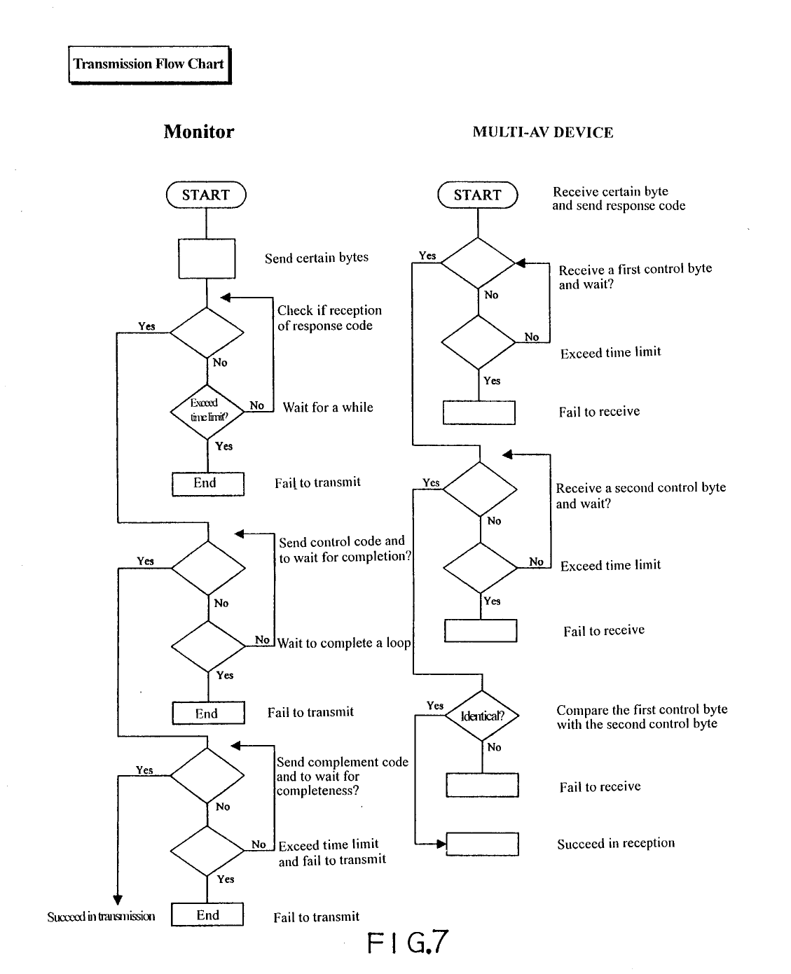

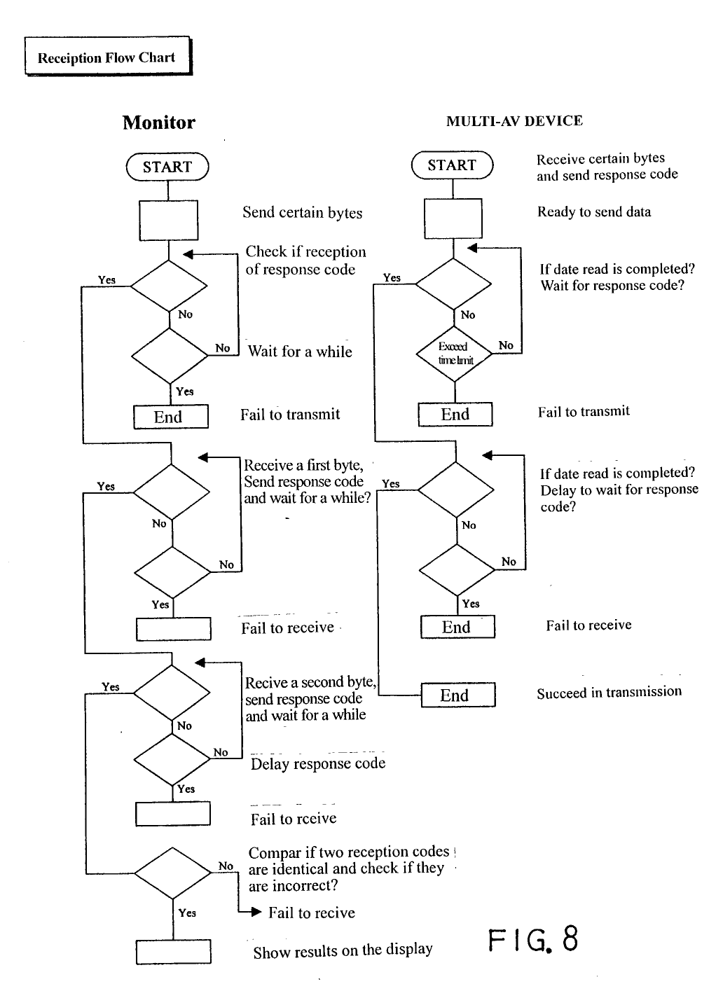

The communication process between the displays 2 and the multi-AV device 1 is shown in FIGS. 7 and 8. The two-way communication is carried out by the microprocessor 17 of the multi-AV device 1 and the microprocessor 27 of the display 2. As shown in FIG. 7, when the display 2 sends certain bytes to the multi-AV device 1, it inquires the response code. During the transmission, the display 2 repeats to transmit signals to the multi-AV device 1 until a successful transmission. Meanwhile, the multi-AV device 1 receives certain bytes to send out response code and repeats to receive and compare until a successful reception.

Again, referring to FIG. 8, after the multi-AV device 1 successfully receives the certain bytes from one display 2, it's ready to send data to the display 2 until they are shown on the display 2.

Based upon the above-mentioned two-way communication between the multi-AV device 1 and the displays 2, the car AV device presents a number of choices. As a result, every passenger can receive the desired AV-signals displayed to the LCD panel 21 by means of every display 2. The sound can be sent out from the displays 2 or the original car speakers 4. The headphone jack 23 of the displays 2 is available for passengers so as not to interfere with one another. The volume control of the car speakers 4 is basically performed only by the display 2 connected to the connection port (PORT 1). Since the connection port (PORT 1) is connected to the sound processor 15 within the multi-AV device 1, the processing mode and the volume are controllable through the sound processor 15. Besides, the control can be shown on the corresponding display 2.

The control of the present invention is performed by means that the command is given by the display 2 to the multi-AV device 1. Unlike the prior art utilizes electronic switch to choose desired AV-signals of the multi-AV device, the present invention can achieve a more convenient and accurate operation. Consequently, it's very suitable to install in the automobiles.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A multi-AV control device in an automobile comprising:
a multi-AV device connected with a plurality of AV-signal input sources and displays; and
a plurality of displays;
wherein said multi-AV device and said displays are provided with a microprocessor and a electrically-erasable programmable read-only memory, and wherein said multi-AV device is controllable by press buttons or a remote control of every display to choose different AV-signal source while the chosen AV-signal source is shown on corresponding display, and wherein the control command is given by said displays to said multi-AV device, whereupon said multi-AV device transmits signals back to said display and which are shown on said corresponding display so that this two-way communication achieves control and display effect.

2. The multi-AV control device in an automobile as recited in claim 1 wherein AV-signal input sources consists of a DVD player, VCP player, TV channel selector, game player, etc.

3. The multi-AV control device in an automobile as recited in claim 1 wherein said multi-AV device includes an AV switch, an IR-sender, a sound processor and a tone amplifier.

4. The multi-AV control device in an automobile as recited in claim 1 wherein each of said displays is provided with press buttons and a headphone jack.
